(19) United States
(12) Patent Application Publication
(10) Pub. No.: US 2015/0201591 A1
(43) Pub. Date: Jul. 23, 2015

(54) Hrdrodynamic Artificial Soft-Plastic Fisshing Bait

(71) Applicant: Michael McCamy Barrett, Sanger, TX (US)

(72) Inventor: Michael McCamy Barrett, Sanger, TX (US)

(21) Appl. No.: 14/594,566

(22) Filed: Jan. 12, 2015

Related U.S. Application Data
(60) Provisional application No. 61/930,836, filed on Jan. 23, 2014.

(51) Int. Cl. A01K 85/01; A01K 91/04; A01K 85/00

(52) U.S. Cl. CPC A01K 85/01; A01K 85/00; A01K 91/04

(57) ABSTRACT

A soft-plastic fishing lure having a contoured round, elongated body portion (1) of circular units (7) of varying diameters, arrangements, and spacing's (5) to mimic natural bait silhouettes and natural sounds. The soft-plastic lure has a ¼ inch continuous interior core (6) and has a head portion (2) attached at one end of the elongated body portion (1) and has a forward facing contoured bulbous head (4) of varying lengths and diameters. A tail portion (3) is attached to the opposite end of the elongated body portion (1) by the continuous ¼ inch core (6) and has an oval appearance (8) when viewed from the top, and a designed hump (9, 13) the full width of the oval with corresponding concave contour (10, 12) on the bottom of the oval. The combination of the various head (2), body (1), and hydro dynamic tail (3) portions creates unique soft-plastic baits which mimic natural baits in appearance, sounds, and hydro dynamic pressure waves. Various scents, colors, flakes, lengths, diameters, heights, and widths are incorporated and implemented for multiple desirable uses and identification.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The invention relates to the field of Soft Plastic/Poly Vinyl artificial fishing baits. Specifically, the invention incorporates different elements combined in multiple combinations to mimic different live baits. Different combinations enable targeting specific species of fish.

2. Description of the Related Baits

Over the years, soft plastic baits have evolved from long, slim “worms” into a multitude of different shapes, colors, sizes, appendages, rattlers, scents, streamers, all meant to mimic naturally occurring live baits. Visual presentation and taste are the primary sensory attractors of these baits and, are the least used senses of most predatory game fish.

The lateral sensing lines down both sides of most predatory game fish are the primary feeding sensors; able to detect frequencies below 1 hertz; known as SPW, or Sound Pressure Wave; and up to and beyond 1,000 hertz. The lateral lines are so sensitive to sound that artificial baits hitting the water near predatory game fish overwhelms its primary sensors. The game fish either flees, or strikes using its eyes. As the distance opens from the game fish, the strike response percentage reduces. Most soft-plastic baits use this near distance method to induce strikes.

When predatory game fish naturally feed, they use their primary feeding sensors to detect the different frequencies produced by naturally occurring baits.

For instance, the popping bubbles of feeding natural bait, or the sound of the gravel moving as it hunts for food, or the movement of its appendages. These three examples are of high frequency, low frequency, and SPW. In water, high frequencies travel shorter distances before becoming either dispersed or absorbed, with low frequency's traveling further and SPW the furthest. Feeding predatory game fish at longer distances respond to SPW stimulus to target bait, followed by low frequency to localize bait, and finally, high frequency and eye sight to attack and feed. The present invention mimics closely multiple frequencies and SPWs of live natural baits to stimulate long range aggressive bites.

### BRIEF SUMMARY OF THE PRESENT INVENTION

The present invention has a contoured, round elongated body portion comprised of circular units attached in the center to a ¼ inch continuous core, centered at distances from 1/64^{th} inch to 1/16^{th} inch. Different diameter circular units in varying arrangements create many contour combinations and capture air bubbles to create high frequency's, which visually and acoustically mimic different natural baits.

A solid head portion of the present invention is attached on the front end by the continuous ¼ inch core and has a forward facing contoured bulbous appearance of various lengths and girths. Varying arrangements create many visual contour combinations and provide an initial hook attachment point.

A solid tail portion of the present invention is attached by the continuous ¼ inch core to the end, and has a modified oval appearance when viewed from the top, with a designed hump across the width of the oval.

The tail is flat on the bottom and in line with the bottom of the continuous ¼ inch core, and has a concave center which follows the designed hump on the top. Movement of the present invention in water will cause the tail to produce SPW's. Various size and arch ovals and design hump heights will produce various SPW's which mimic different natural baits. The combination of all portions creates the unique, hydro-dynamic present invention which mimics natural baits appearances, sounds, and sound pressure waves. Various colors, highlights, metal flakes, lengths, girths, and tails are incorporated and implemented for multiple desired uses and identification.

### BRIEF DESCRIPTION OF ITEMS IN THE DRAWINGS

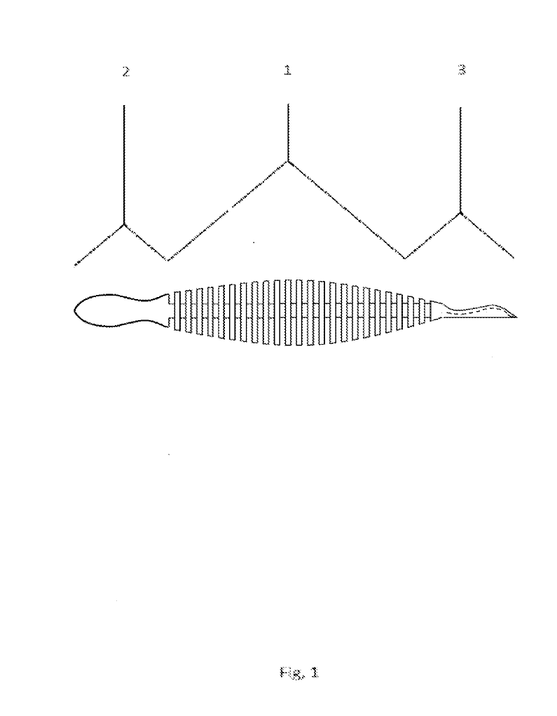

FIG. 1
1. Body Portion.
2. Head Portion.
3. Tail Portion.

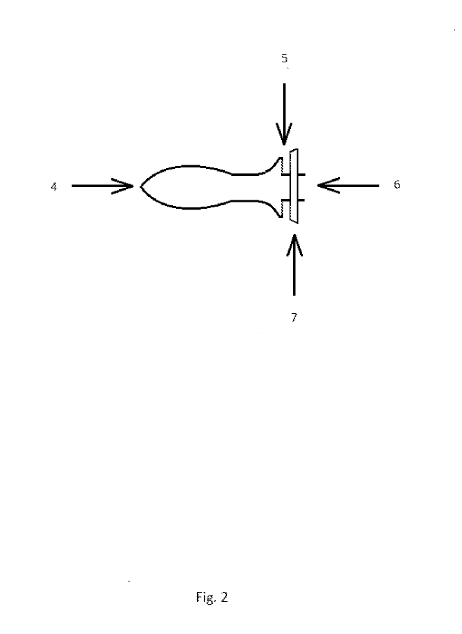

FIG. 2
4. Bulbous, Contoured [symbol]
5. Circular Unit Spacing.
6. Continuous ¼ inch [symbol]
7. Circular Unit.

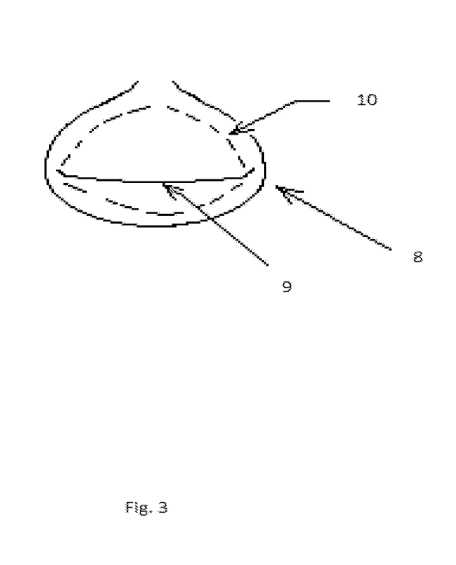

FIG. 3
8. Modified Oval Appearance Tail Portion.
9. Designed Upper Hump.
10. Concave Bottom.

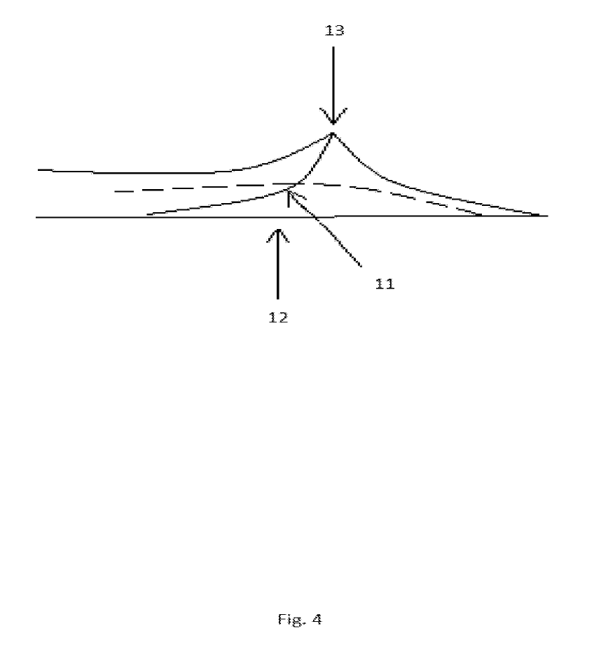

FIG. 4
11. Contoured Hump.
12. Concave Contoured Bottom.
13. Contour Hump Height

### DETAILED DESCRIPTION OF INVENTION

FIG. 1 shows the three portions (1, 2, and 3) of the invention together to show one possible combination. The overall length of the invention is determined by the combination of lengths of each portion. Overall diameters vary for each portion. Overall length is from 2½ inches to 8 inches. Overall diameter is from 1/8 inch to 3 inches.

FIG. 2 shows the head portion of the invention with the first circular spacing (5) of 1/64^{th} inch to 1/16^{th} inch, the continuous ¼ inch core (6), and the first circular unit (7) of the body portion. The contoured bulbous head (4) is the portion of the drawing from the tip of the head to the first circular spacing. Head portion length is from ¼ inch to 2 inches. Head portion overall diameter is from ⅛ inch to 2 inches.

FIG. 3 is the top view of the invention tail portion showing the modified oval appearance (8), the designed upper hump (9), and the hidden view of the concave lower (10). The modified oval (8) width is from ½ inch to 3 inches. The designed hump (9) width is from ½ inch to 3 inches. The hidden concave lower (10) follows the selected modified oval (8) width and designed hump (9) height (13).

FIG. 4 is the side view of the invention tail portion showing the contoured hump (11), concave contoured bottom (12), and the contoured height (13). The contoured height (13) is from equal to 1¾ inches above the continuous ¼ inch center core (6).

Having described the invention, I claim:

1. The invention using the modified hump contoured portion hydro dynamically produces very low frequencies and sound pressure waves attracting feeding game fish by mimicking natural baits.

2. The invention using the body portion captures air as small bubbles which statically release at different depths based on the spacing of the circular elements producing medium to high frequencies and providing a visual mimicking of feeding natural baits.

3. The invention using the head portion provides an anchor point for a hook shank and by embedding the point of the hook in the body portion at different axis the invention changes orientation and further mimic's natural baits.

4. The invention using the three portions provides a hydrodynamic artificial soft-plastic fishing bait that sub-acoustically, acoustically, and visually mimics natural, feeding baits.
